(19) United States
(12) Patent Application Publication
(10) Pub. No.: US 2013/0143061 A1
(43) Pub. Date: Jun. 6, 2013

(54) Grid-Reinforced Insulation Board

(71) Applicants: Jinlie Zhou, Shanghai (CN); Yue Zhou, Shanghai (CN)

(72) Inventors: Jinlie Zhou, Shanghai (CN); Yue Zhou, Shanghai (CN)

(21) Appl. No.: 13/814,444

(22) PCT Filed: Jul. 29, 2011
(86) PCT No.: PCT/CN2011/077778

§ 371 Date: Feb. 5, 2013

(30) Foreign Application Priority Data
Aug. 6, 2010 (CN) 201020283546.X
Sep. 28, 2010 (CN) 201020545238.X
Oct. 9, 2010 (CN) 201020553655.9
Oct. 9, 2010 (CN) 201020553667.1
Nov. 3, 2010 (CN) 201020591095.6

(51) Int. Cl. B32B 5/26; B32B 3/26; B32B 19/06; B32B 5/02

(52) U.S. Cl. CPC B32B 5/26; B32B 5/026; B32B 3/266; B32B 19/06
USPC 428/608; 442/1

(57) ABSTRACT

A grid-reinforced insulation board includes an insulation core board (1), a bidirectional grid reinforcer (2) provided underneath a surface layer thereof and an insulation board protective layer (3) of the bidirectional grid reinforcer (2) provided on an outer surface thereof. The bidirectional grid reinforcer (2) is formed by glass fibers, metal fibers and man-made fiber to improve a tensile strength and a folding strength thereof. The insulation board protective layer (3) is able to improve the corrosion resistance of the bidirectional grid reinforcer (2).

### CROSS REFERENCE OF RELATED APPLICATION

This is a U.S. National Stage under 35 U.S.C 371 of the International Application PCT/CN2011/07778, filed Jul. 29, 2011, which claims priority under 35 U.S.C. 119(a-d) to CN 201020283546.X, filed Aug. 6, 2010.

### BACKGROUND OF THE PRESENT INVENTION

1. Field of Invention

The present invention relates to a bidirectional grid-reinforced insulation board provided underneath a surface layer thereof, and more particularly to an external thermal insulation wall provided with the insulation board anchored by a mechanical fixing device.

2. Description of Related Arts

Currently, a conventional insulation board is produced by the thermal insulation board material through the working process of machining, solidifying, shaping and cutting, which is characterized by the satisfying density, thermal conductivity and combustion performance, but the tensile strength and the flexural strength is poor, and it is likely to be cracked, be out of shape and shrink. When the insulation board is used for an external thermal insulation wall anchored by a mechanical fixing device, there are some problems and shortcomings of the thermal insulation board anchored such as low peeling strength, bad entirety and easy breaking, which should be improved.

### SUMMARY OF THE PRESENT INVENTION

In order to overcome the shortcoming of low stability of a conventional insulation board anchored by a mechanical fixing device, the present invention provides a grid-reinforced insulation board which is able to improve a tensile strength and a folding strength thereof, so as to enhance mechanical properties and whole stability of an external thermal insulation system of the insulation board.

A technical scheme adopted by the present invention is as follows. A two-dimensional grid reinforcer is disposed in a surface layer of an insulation board. The grid reinforcer is made of a glass fiber grid, a metal grid or a man-made fiber grid. A characteristic of the grid reinforcer is that an insulation board protective layer is disposed on an outer surface of the grid reiwnforcer, which isolates the grid reinforcer from an external environment of the insulation board, such as a thin layer of plastering mortar on the insulation board surface, and improves corrosion resistance and durability of the thermal insulation board. A glass fiber grid reinforcer can be disposed in double sides or a single side of the insulation board, according to requirement.

The insulation board is a rock wool insulation board, a polyurethane insulation board, a phenolic insulation board, a glass wool insulation board, a mineral wool insulation board or a modified expanded perlite insulation board.

The glass fiber grid reinforcer is formed by knitting decussations of glass fiber warps and wefts. A distance between the grid apertures of the rock wool insulation board grid reinforcer, the polyurethane insulation board grid reinforcer, the glass wool insulation board grid reinforcer or the mineral wool insulation board grid reinforcer is 5˜25×5˜25 mm, optimally 7˜15×7˜15 mm; a thickness of the insulation board protective layer of the reinforcer, i.e., a distance between the grid reinforcer and the outer surface edge of the insulation board is 5˜25 mm, optimally 8˜12 mm. A distance between the grid apertures of the phenolic insulation board grid reinforcer and the modified expanded perlite insulation board grid reinforcer is 5˜30×5˜30 mm, optimally 7˜20×7˜20 mm; a thickness of the insulation board protective layer of the reinforcer, i.e., a distance between the grid reinforcer and the outer surface edge of the insulation board is 7˜40 mm, optimally 10˜30 mm.

The metal fiber grid reinforcer mentioned above is formed by electric welding decussations of longitudinal steel wires and transverse steel wires. The metal fiber grid reinforcer is a hot-galvanized steel wire, a cold drawn low carbon steel wire, a stainless steel wire or an alloy steel wire. A diameter of the steel wire is 0.5˜4.0 mm, optimally 0.9˜2.5 mm. A distance between the grid apertures of the metal fiber grid reinforcer is 5˜60×5˜60 mm, optimally 10˜30×10˜30 mm. The thickness of the grid insulation board protective layer of the rock wool insulation board grid reinforcer, the polyurethane insulation board grid reinforcer, the glass wool insulation board grid reinforcer or the mineral wool insulation board grid reinforcer is 5˜50 mm, optimally 8˜30 mm. The thickness of the grid insulation board protective layer of the phenolic insulation board grid reinforcer and the modified expanded perlite insulation board grid reinforcer is 7˜50 mm, optimally 10˜40 mm.

The man-made fiber grid reinforcer mentioned above is formed by knitting decussations of man-made fiber warps and man-made fiber wefts. The man-made fiber is a polyester fiber, a polyamide fiber, a polyacrylonitrile fiber, a polyvinyl alcohol fiber or a polyolefin fiber. The distance between the grid apertures of the man-made fiber grid reinforcer of the rock wool insulation board, the glass wool insulation board or the mineral wool insulation board is 5˜20×5˜20 mm, optimally 7˜15×7˜15 mm; the thickness of the insulation board protective layer of the man-made fiber grid reinforcer is 5˜25 mm, optimally 8˜12 mm. The distance between the grid apertures of the man-made fiber grid reinforcer of the polyurethane insulation board is 5˜25×5˜25 mm, optimally 7˜15×7˜15 mm; the thickness of the insulation board protective layer of the man-made fiber grid reinforcer is 5˜25 mm, optimally 8˜12 mm. The distance between the grid apertures of the man-made fiber grid reinforcer of the phenolic insulation board and the modified expanded perlite insulation board is 5˜30×5˜30 mm, optimally 7˜20×7˜20 mm; the thickness of the insulation board protective layer of the man-made fiber grid reinforcer is 7˜40 mm, optimally 10˜30 mm.

Through the working process of machining, pressing and solidifying, the grid reinforcer and the insulation board are accomplished to mold at a time, the grid reinforcer is disposed in the surface layer of the insulation board according to the present invention, so as to ensure the integrity and airtightness of the insulation board body that is inside or outside the grid reinforcer.

The present invention grid reinforced insulation board has the advantages as follows. Compared with a conventional insulation board, the grid reinforced insulation board significantly improves tensile strength and folding strength thereof. The present invention is suitable for an external thermal insulation wall of the insulation board anchored by a mechanical fixing device, and can solve a problem that the insulation board has the shortcomings of brittleness and easy breaking.

### BRIEF DESCRIPTION OF THE DRAWINGS

Specific characteristics and properties of the present invention are further illustrated by preferred embodiments and drawings according to the preferred embodiments as follows.

FIG. 1 is a structure diagram of the present invention.

FIG. 2 is a longitudinal section diagram of FIG. 1.

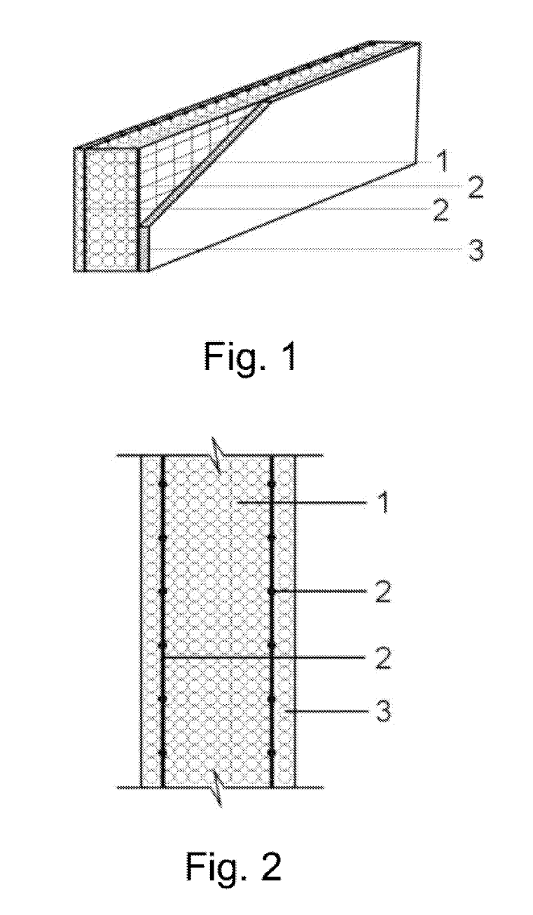

In FIG. 1 and FIG. 2, 1—insulation core board, 2—grid reinforcer, 3—insulation board protective layer of the reinforcer.

### DETAILED DESCRIPTION OF THE PREFERRED EMBODIMENT

In FIG. 1 and FIG. 2, a grid-reinforced insulation board according to the present invention from inside to outside sequentially consists of an insulation core board 1, a grid reinforcer 2 and an insulation board protective layer 3 of the reinforcer 2. The insulation core board is a rock wool insulation board, a polyurethane insulation board, a phenolic insulation board, a glass wool insulation board, a mineral wool insulation board or a modified expanded perlite insulation board. The rock wool insulation board is a pendulum method rock wool board or a three-dimensional method rock wool board. The polyurethane insulation board is a foam polyurethane board or a modified polyurethane board. The phenolic insulation board is a phenolic foam board or a modified phenolic board. The glass wool insulation board is a glass wool board without an outer covering or a glass wool board with an outer covering. The mineral wool insulation board is a granulated slag wool board, or a semi-rigid mineral wool board. The modified expanded perlite board is a high hardness and low water absorbing capacity expansion perlite board which uses XR plant protein contents such as glue additives to modify the expanded perlite. The grid reinforcer 2 is formed by knitting decussations of warps and wefts made of glass fiber or man-made fiber fabric, or by electric welding decussations of longitudinal steel wires and transverse steel wires. The material of the insulation board protective layer 3 and the polystyrene core board 1 is the same. The insulation board protective layer 3 of the reinforcer 2 and the polystyrene core board 1 form an integral board, which isolates the grid reinforcer 2 from an external environment, such as a thin layer of plastering mortar on the insulation board surface, and prevents the reinforcer from alkalization and corrosion.

1-8. (canceled)

9. A grid-reinforced rock wool insulation board, comprising a rock wool insulation board and a two-dimensional grid reinforcer layer disposed in a surface layer of said insulation board, a grid reinforcer is selected from the group consisting of a glass fiber grid reinforcer, a metal fiber grid reinforcer, and a man-made fiber grid reinforcer, wherein a rock wool insulation board protective layer is disposed on an outer surface of said grid reinforcer, which isolates said grid reinforcer from an external environment including a thin layer of plastering mortar to prevent said reinforcer from alkalization and corrosion; through a working process of machining, pressing and solidifying, said grid reinforcer is disposed in said surface layer of said insulation board at a time, said rock wool insulation board protective layer and an insulation core board are combined into a whole integrated board, so as to improve a tensile strength and a bending strength of said insulation board, a fiber grid reinforcer can be disposed in double sides or a single side of said insulation board;
said grid-reinforced insulation board is suitable for an external thermal insulation wall of said insulation board anchored by a mechanical fixing device, so as to solve a problem that said insulation board has shortcomings of weak integrity and easy breaking.

10. The grid-reinforced rock wool insulation board as recited in claim 9, wherein said metal fiber grid reinforcer is formed by electric welding decussations of longitudinal steel wires and transverse steel wires, said metal fiber grid reinforcer is a hot-galvanized steel wire, a cold drawn low carbon steel wire, a stainless steel wire or an alloy steel wire, a diameter of said steel wire is 0.5˜4.0 mm, a distance between said grid apertures of said rock wool insulation board grid reinforcer is 5˜60×5˜60 mm, a thickness of said rock wool insulation board protective layer of said grid reinforcer, i.e., a distance between said grid reinforcer and an outer surface edge of said rock wool insulation board is 5˜50 mm; said glass fiber grid reinforcer is formed by knitting decussations of glass fiber warps and wefts, said distance between said grid apertures of said rock wool insulation board grid reinforcer is 5˜25×5˜25 mm, said thickness of said rock wool insulation board protective layer of said grid reinforcer, i.e., said distance between said grid reinforcer and said outer surface edge of said rock wool insulation board is 5˜25 mm, said man-made fiber grid reinforcer is formed by knitting decussations of man-made fibers warps and fibers wefts, said man-made fiber is a polyester fiber, a polyamide fiber, a polyacrylonitrile fiber, a polyvinyl alcohol fiber or a polyolefin fiber, said distance between said grid apertures of said rock wool insulation board grid reinforcer is 5˜20×5˜20 mm, said thickness of said rock wool insulation board protective layer of said grid reinforcer is 5˜25 mm.

11. The grid-reinforced rock wool insulation board as recited in claim 9, wherein said diameter of said steel wire is optimally 0.9˜2.5 mm, said distance between said grid apertures of said rock wool insulation board grid reinforcer is optimally 10˜30×10˜30 mm, and said thickness of said rock wool insulation board protective layer of said grid reinforcer is optimally 8˜30 mm; said distance between said grid apertures of said glass fiber grid reinforcer or said man-made fiber grid reinforcer is optimally 7˜15×7˜15 mm, said thickness of said rock wool insulation board protective layer of said grid reinforcer is optimally 8˜12 mm.

12. A grid-reinforced glass wool insulation board, comprising a glass wool insulation board and a two-dimensional grid reinforcer layer disposed in a surface layer of said insulation board, a grid reinforcer is selected from the group consisting of a glass fiber grid reinforcer, a metal fiber grid reinforcer, and a man-made fiber grid reinforcer, wherein a glass wool insulation board protective layer is disposed on an outer surface of said grid reinforcer, which isolates said grid reinforcer from an external environment including a thin layer of plastering mortar to prevent said reinforcer from alkalization and corrosion; through a working process of machining, pressing and solidifying, said grid reinforcer is disposed in said surface layer of said insulation board at a time, said glass wool insulation board protective layer and an insulation core board are combined into a whole integrated board, so as to improve a tensile strength and a bending strength of said insulation board, said fiber grid reinforcer can be disposed in double sides or a single side of said insulation board; said grid-reinforced insulation board is suitable for an external thermal insulation wall of said insulation board anchored by a mechanical fixing device, so as to solve a problem that said insulation board has shortcomings of weak integrity and easy breaking; said man-made fiber grid reinforcer is formed by knitting decussations of man-made fiber warps and man-made fiber wefts, said man-made fiber is a polyester fiber, a polyamide fiber, a polyacrylonitrile fiber, a polyvinyl alcohol fiber or a polyolefin fiber, a distance between said grid apertures of said man-made fiber grid reinforcer of said glass wool insulation board is 5˜20×5˜20 mm; a thickness of said glass wool insulation board protective layer of said grid reinforcer, i.e., said distance between said grid reinforcer and said outer surface edge of said glass wool insulation board is 5˜25 mm.

13. The grid-reinforced glass wool insulation board as recited in claim 12, wherein said glass fiber grid reinforcer is formed by knitting decussations of glass fiber warps and wefts, said distance between said grid apertures of said glass wool insulation board grid reinforcer is 5˜25×5˜25 mm, said thickness of said glass wool insulation board protective layer of said grid reinforcer, i.e., said distance between said grid reinforcer and said outer surface edge of said glass wool insulation board is 5˜25 mm; said metal fiber grid reinforcer is formed by electric welding decussations of longitudinal steel wires and transverse steel wires, said metal fiber grid reinforcer is a hot-galvanized steel wire, a cold drawn low carbon steel wire, a stainless steel wire or an alloy steel wire, said diameter of said steel wire is 0.5˜4.0 mm, said distance between said grid apertures of said glass wool insulation board grid reinforcer is 5˜60×5˜60 mm, said thickness of said glass wool insulation board protective layer of said grid reinforcer is 5˜50 mm.

14. The grid-reinforced glass wool insulation board as recited in claim 12, wherein said distance between said grid apertures of said glass fiber grid reinforcer or said man-made fiber grid reinforcer is optimally 7˜15×7˜15 mm, said thickness of said glass wool insulation board protective layer of said grid reinforcer is optimally 8˜12 mm; said diameter of said steel wire is optimally 0.9˜2.5 mm, said distance between said grid apertures of said glass wool insulation board grid reinforcer is optimally 10˜30×10˜30 mm, and said thickness of said glass wool insulation board protective layer of said grid reinforcer is optimally 8˜30 mm.

15. A grid-reinforced mineral wool insulation board, comprising a mineral wool insulation board and a two-dimensional grid reinforcer layer disposed in a surface layer of said insulation board, a grid reinforcer is selected from the group consisting of a glass fiber grid reinforcer, a metal fiber grid reinforcer, and a man-made fiber grid reinforcer, wherein a mineral wool insulation board protective layer is disposed on an outer surface of said grid reinforcer, which isolates said grid reinforcer from an external environment including a thin layer of plastering mortar to prevent said reinforcer from alkalization and corrosion; through a working process of machining, pressing and solidifying, said grid reinforcer is disposed in said surface layer of said insulation board at a time, said mineral wool insulation board protective layer and an insulation core board are combined into a whole integrated board, so as to improve a tensile strength and a bending strength of said insulation board, a fiber grid reinforcer can be disposed in double sides or a single side of said insulation board; said grid-reinforced insulation board is suitable for an external thermal insulation wall of said insulation board anchored by a mechanical fixing device, so as to solve a problem that said insulation board has shortcomings of weak integrity and easy breaking; said man-made fiber grid reinforcer is formed by knitting decussations of man-made fiber warps and man-made fiber wefts, said man-made fiber is a polyester fiber, a polyamide fiber, a polyacrylonitrile fiber, a polyvinyl alcohol fiber or a polyolefin fiber, a distance between said grid apertures of said man-made fiber grid reinforcer of said mineral wool insulation board is 5˜20×5˜20 mm; said thickness of said mineral wool insulation board protective layer of said grid reinforcer, i.e., said distance between said grid reinforcer and said outer surface edge of said mineral wool insulation board is 5˜25 mm.

16. The grid-reinforced mineral wool insulation board as recited in claim 15, wherein said glass fiber grid reinforcer is formed by knitting decussations of glass fiber warps and wefts, said distance between said grid apertures of said mineral wool insulation board grid reinforcer is 5˜25×5˜25 mm, said thickness of said mineral wool insulation board protective layer of said grid reinforcer, i.e., said distance between said grid reinforcer and said outer surface edge of said mineral wool insulation board is 5˜25 mm; said metal fiber grid reinforcer is formed by electric welding decussations of longitudinal steel wires and transverse steel wires, said metal fiber grid reinforcer is a hot-galvanized steel wire, a cold drawn low carbon steel wire, a stainless steel wire or an alloy steel wire, said diameter of said steel wire is 0.5˜4.0 mm, said distance between said grid apertures of said mineral wool insulation board grid reinforcer is 5˜60×5˜60 mm, said thickness of said mineral wool insulation board protective layer of said grid reinforcer is 5˜50 mm.

17. The grid-reinforced mineral wool insulation board as recited in claim 15, wherein said distance between said grid apertures of said glass fiber grid reinforcer or said man-made fiber grid reinforcer is optimally 7˜15×7˜15 mm, said thickness of said mineral wool insulation board protective layer of said grid reinforcer is optimally 8˜12 mm; said diameter of said steel wire is optimally 0.9˜2.5 mm, said distance between said grid apertures of said mineral wool insulation board grid reinforcer is optimally 10˜30×10˜30 mm, and said thickness of said mineral wool insulation board protective layer of said grid reinforcer is optimally 8˜30 mm.

18. A grid-reinforced phenolic insulation board, comprising an phenolic insulation board and a two-dimensional grid reinforcer layer disposed in a surface layer of said insulation board, a grid reinforcer is selected from the group consisting of a glass fiber grid reinforcer, a metal fiber grid reinforcer, and a man-made fiber grid reinforcer, wherein a phenolic insulation board protective layer is disposed on an outer surface of said grid reinforcer, which isolates said grid reinforcer from an external environment including a thin layer of plastering mortar to prevent said reinforcer from alkalization and corrosion; through a working process of machining, pressing and solidifying, said grid reinforcer is disposed in said surface layer of said insulation board at a time, said phenolic insulation board protective layer and an insulation core board are combined into a whole integrated board, so as to improve a tensile strength and a bending strength of said insulation board, said fiber grid reinforcer can be disposed in double sides or a single side of said insulation board; said grid-reinforced insulation board is suitable for an external thermal insulation wall of said insulation board anchored by a mechanical fixing device, so as to solve a problem that said insulation board has shortcomings of weak integrity and easy breaking; said glass fiber grid reinforcer is formed by knitting decussations of glass fiber warps and glass fiber wefts, a distance between said grid apertures of said glass fiber grid reinforcer of said phenolic insulation board is 5˜30×5˜30 mm; a thickness of said phenolic insulation board protective layer of said grid reinforcer, i.e., said distance between said grid reinforcer and said outer surface edge of said phenolic insulation board is 7˜40 mm.

19. The grid-reinforced phenolic insulation board as recited in claim 18, wherein said metal fiber grid reinforcer is formed by knitting decussations of metal fiber warps and wefts, said metal fiber grid reinforcer is a hot-galvanized steel wire, a cold drawn low carbon steel wire, a stainless steel wire or an alloy steel wire, said diameter of said steel wire is 0.5˜4.0 mm, wherein said distance between said grid apertures of said metal fiber grid reinforcer is 5˜60×5˜60 mm, said thickness of said phenolic insulation board protective layer of said grid reinforcer is 7˜50 mm; said man-made fiber grid reinforcer is formed by knitting decussations of man-made fibers warps and fibers wefts, said man-made fiber is a polyester fiber, a polyamide fiber, a polyacrylonitrile fiber, a polyvinyl alcohol fiber or a polyolefin fiber, a distance between said grid apertures of said phenolic insulation board grid reinforcer is 5˜30×5˜30 mm, said thickness of said phenolic insulation board protective layer of said grid reinforcer is 7˜40 mm.

20. The grid-reinforced phenolic insulation board as recited in claim 18, wherein said distance between said grid apertures of said glass fiber grid reinforcer or said man-made fiber grid reinforcer is optimally 7˜20×7˜20 mm, said thickness of said phenolic insulation board protective layer of said grid reinforcer is optimally 10˜30 mm; said metal fiber grid reinforcer is formed by electric welding decussations of longitudinal steel wires and transverse steel wires, said diameter of said steel wire is optimally 0.9˜2.5 mm, said distance between said grid apertures of said phenolic insulation board grid reinforcer is optimally 10˜30×10˜30 mm, and said thickness of said phenolic insulation board protective layer of said grid reinforcer is optimally 10˜40 mm.

21. A grid-reinforced modified expanded perlite insulation board, comprising an modified expanded perlite insulation board and a two-dimensional grid reinforcer layer disposed in a surface layer of said insulation board, said grid reinforcer is selected from the group consisting of a glass fiber grid reinforcer, a metal fiber grid reinforcer, and a man-made fiber grid reinforcer, wherein a modified expanded perlite insulation board protective layer is disposed on an outer surface of said grid reinforcer, which isolates said grid reinforcer from an external environment including a thin layer of plastering mortar to prevent said reinforcer from alkalization and corrosion; through a working process of machining, pressing and solidifying, said grid reinforcer is disposed in said surface layer of said insulation board at a time, said modified expanded perlite insulation board protective layer and an insulation core board are combined into a whole integrated board, so as to improve a tensile strength and a bending strength of said insulation board, said fiber grid reinforcer can be disposed in double sides or a single side of said insulation board; said grid-reinforced insulation board is suitable for an external thermal insulation wall of said insulation board anchored by a mechanical fixing device, so as to solve a problem that said insulation board has shortcomings of weak integrity and easy breaking; said glass fiber grid reinforcer is formed by knitting decussations of glass fiber warps and glass fiber wefts, a distance between said grid apertures of said glass fiber grid reinforcer of said modified expanded perlite insulation board is 5˜30×5˜30 mm, a thickness of said modified expanded perlite insulation board protective layer of said grid reinforcer, i.e., said distance between said grid reinforcer and said outer surface edge of said modified expanded perlite insulation board is 7˜40 mm.

22. The grid-reinforced modified expanded perlite insulation board as recited in claim 21, wherein said metal fiber grid reinforcer is formed by knitting decussations of metal fiber warps and wefts, said metal fiber grid reinforcer is a hot-galvanized steel wire, a cold drawn low carbon steel wire, a stainless steel wire or an alloy steel wire, said diameter of said steel wire is 0.5˜4.0 mm, wherein said distance between said grid apertures of said metal fiber grid reinforcer is 5˜60×5˜60 mm, said thickness of said modified expanded perlite insulation board protective layer of said grid reinforcer is 7˜50 mm; said man-made fiber grid reinforcer is formed by knitting decussations of man-made fibers warps and fibers wefts, said man-made fiber is a polyester fiber, a polyamide fiber, a polyacrylonitrile fiber, a polyvinyl alcohol fiber or a polyolefin fiber, said distance between said grid apertures of said modified expanded perlite insulation board grid reinforcer is 5˜30×5˜30 mm, said thickness of said modified expanded perlite insulation board protective layer of said grid reinforcer is 7˜40 mm.

23. The grid-reinforced modified expanded perlite insulation board as recited in claim 21, wherein said distance between said grid apertures of said glass fiber grid reinforcer or said man-made fiber grid reinforcer is optimally 7˜20×7˜20 mm, said thickness of said modified expanded perlite insulation board protective layer of said grid reinforcer is optimally 10˜30 mm; said metal fiber grid reinforcer is formed by electric welding decussations of longitudinal steel wires and transverse steel wires, said diameter of said steel wire is optimally 0.9˜2.5 mm, said distance between said grid apertures of said modified expanded perlite insulation board grid reinforcer is optimally 10˜30×10˜30 mm, and said thickness of said modified expanded perlite insulation board protective layer of said grid reinforcer is optimally 10˜40 mm.

24. A grid-reinforced polyurethane insulation board, comprising an polyurethane insulation board and a two-dimensional grid reinforcer layer disposed in a surface layer of said insulation board, a grid reinforcer is selected from the group consisting of a glass fiber grid reinforcer, a metal fiber grid reinforcer, and a man-made fiber grid reinforcer, wherein a polyurethane insulation board protective layer is disposed on an outer surface of said grid reinforcer, which isolates said grid reinforcer from an external environment including a thin layer of plastering mortar to prevent said reinforcer from alkalization and corrosion; through a working process of machining, pressing and solidifying, said grid reinforcer is disposed in said surface layer of said insulation board at a time, said polyurethane insulation board protective layer and an insulation core board are combined into a whole integrated board, so as to improve a tensile strength and a bending strength of said insulation board, said fiber grid reinforcer is disposed in double sides or a single side of said insulation board; said grid-reinforced insulation board is suitable for an external thermal insulation wall of said insulation board anchored by a mechanical fixing device, so as to solve a problem that said insulation board has shortcomings of weak integrity and easy breaking; said metal fiber grid reinforcer is formed by electric welding decussations of longitudinal steel wires and transverse steel wires, said metal fiber grid reinforcer is a hot-galvanized steel wire, a cold drawn low carbon steel wire, a stainless steel wire or an alloy steel wire, a diameter of said steel wire is 0.5˜4.0 mm, a distance between said grid apertures of said polyurethane insulation board grid reinforcer is 5˜60×5˜60 mm, a thickness of said polyurethane insulation board protective layer of said grid reinforcer is 5˜50 mm.

25. The grid-reinforced polyurethane insulation board as recited in claim 24, wherein said glass fiber grid reinforcer is formed by knitting decussations of glass fiber warps and wefts, said distance between said grid apertures of said polyurethane insulation board grid reinforcer is 5˜25×5˜25 mm, said thickness of said polyurethane insulation board protective layer of said grid reinforcer, i.e., said distance between said grid reinforcer and said outer surface edge of said polyurethane insulation board is 5˜25 mm; said man-made fiber grid reinforcer is formed by knitting decussations of man-made fibers warps and fibers wefts, said man-made fiber is a polyester fiber, a polyamide fiber, a polyacrylonitrile fiber, a polyvinyl alcohol fiber or a polyolefin fiber, said distance between said grid apertures of said polyurethane insulation board grid reinforcer is 5˜25×5˜25 mm, said thickness of said polyurethane insulation board protective layer of said grid reinforcer is 5˜25 mm; said diameter of said steel wire is optimally 0.9˜2.5 mm, said distance between said grid apertures of said polyurethane insulation board grid reinforcer is optimally 10˜30×10˜30 mm, and said thickness of said polyurethane insulation board protective layer of said grid reinforcer is optimally 8˜30 mm.

26. The grid-reinforced polyurethane insulation board as recited in claim 24, wherein said distance between said grid apertures of said glass fiber grid reinforcer or said man-made fiber grid reinforcer is optimally 7˜15×7˜15 mm, said thickness of said polyurethane insulation board protective layer of said grid reinforcer is optimally 8˜12 mm.
